(19) United States
(12) Patent Application Publication
(10) Pub. No.: US 2008/0084416 A1
(43) Pub. Date: Apr. 10, 2008

(54) User-pluggable rendering engine

(75) Inventors: Jon Vincent, Seattle, WA (US); Tychaun Jones, Bothell, WA (US); James Drage, Seattle, WA (US); Andy Dadi, Seattle, WA (US); Shashank Gupta, Kirkland, WA (US); Bill Suckow, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/544,458

(22) Filed: Oct. 6, 2006

(51) Int. Cl. G06T 11/20

(52) U.S. Cl. 345/441; 345/619; 345/473

(57) ABSTRACT

A rendering engine allows users to define properties used to render, animate or otherwise represent objects (such as graphic objects, sound players, feedback force generators, and the like) so that the properties are used by the rendering engine to render the object. Users can also define a timeline to control the rendering of the object from a starting time to an ending time.

### BACKGROUND

Computers use graphics, animation, sounds, force feedback, and the like to provide feedback and other information to a user. Conventional utilities for providing animation define a set of properties that cannot normally be changed by a user. It is also difficult to synchronize utilities for sound, graphics, force feedback, and animation using the conventional utilities.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The present disclosure is directed to the rendering engine that allows users to define properties used to render, animate or otherwise represent objects (such as graphic objects, sound players, feedback force generators, and the like) with the rendering engine. Multiple facets of a software application (such as graphics, sound, force feedback, and the like) can be controlled by arbitrary code defined by a user.

Animation of properties can occur without being aware of the actual property implementation because the properties are represented abstractly. Additionally, the properties can be animated using arbitrary timelines. The rendering engine framework allows developers to “plug-in” custom effects (that build upon existing types) to enable development of complex, multi-layered rendering user interface experiences to a novice class of developers. Furthermore, the framework allows developers to use the rendering engine in non-traditional spaces.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for preview expansion of list items.

FIG. 2 is an illustration of a high-level diagram of a user-pluggable rendering engine.

FIG. 3 is an illustration of a flow diagram of user-controlled rendering.

### DETAILED DESCRIPTION

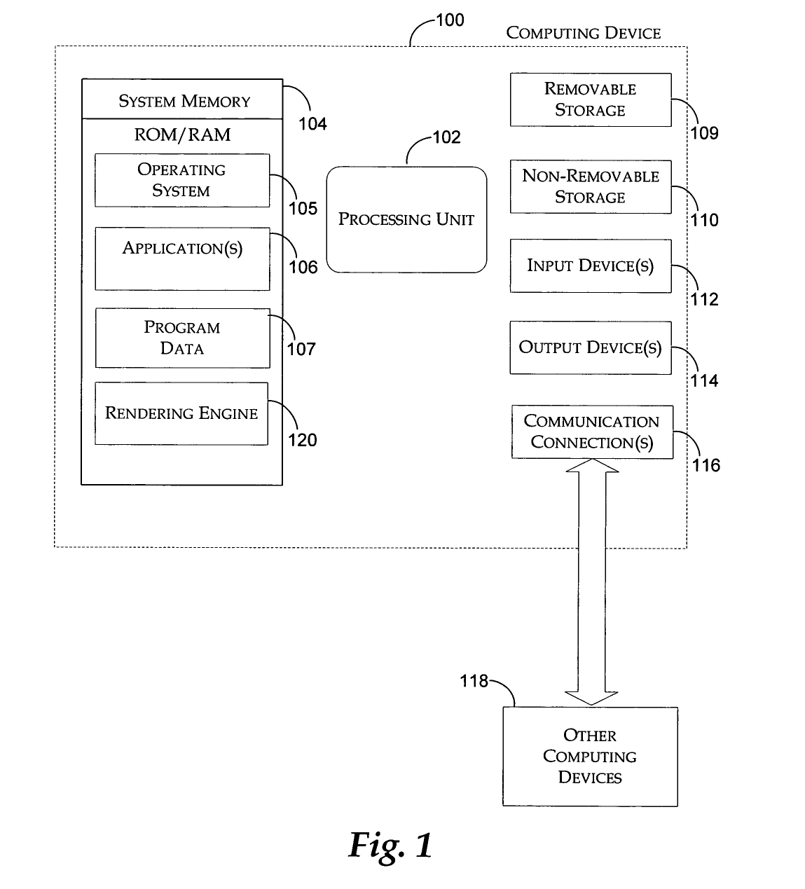

As briefly described above, embodiments are directed to dynamic computation of identity-based attributes. With reference to FIG. 1, one example system for expansion of list items for previewing includes a computing device, such as computing device 100. Computing device 100 may be configured as a client, a server, a mobile device, or any other computing device that interacts with data in a network based collaboration system. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 in which rendering engine 120, can be implemented in conjunction with processing 102, for example.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

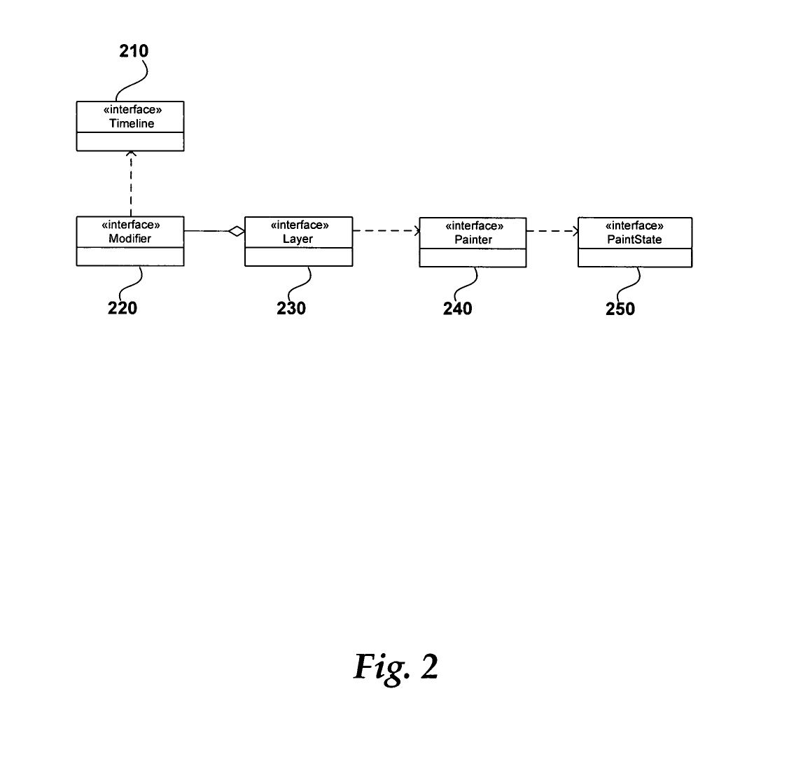

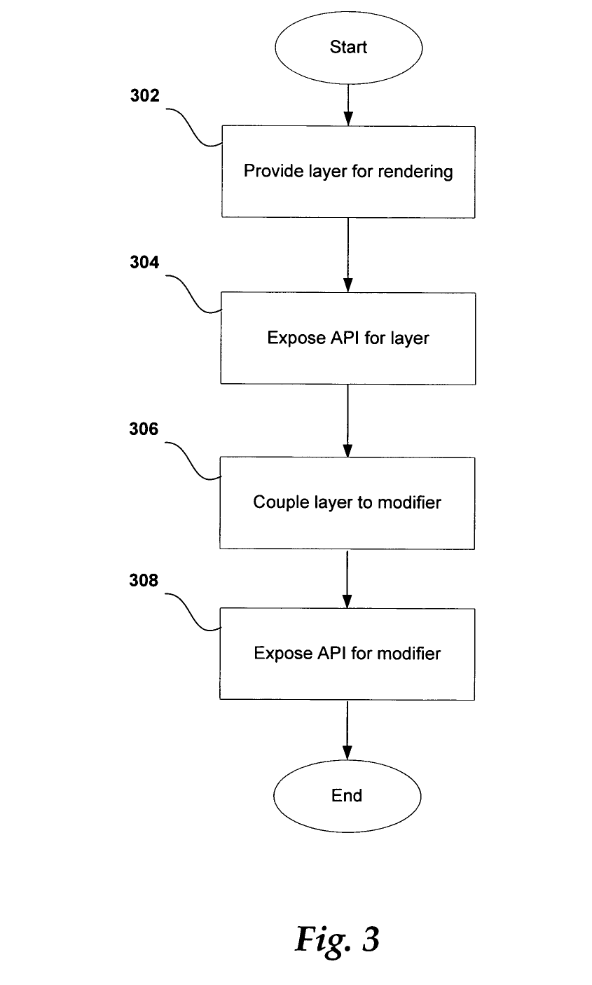

In accordance with the discussion above, computing device 100 system memory 104, processor 102, and related peripherals can be used to implement rendering engine 120. Rendering engine 120 in an embodiment can be used to allow user control of the animation of rendered objects (described below with reference to FIGS. 2-3).

The rendering engine framework provides a unified rendering engine that allows a novice developer to use the rendering engine to control the user-defined properties in response to a clock or other input variables. For example, a developer can create a property that denotes the tempo of a music file. The tempo property can be associated with an arbitrary timeline and supplied to the rendering engine. The rendering engine can animate the tempo property, without knowing the specific meaning of the tempo property, because the rendering engine framework abstracts the property meaning.

Furthermore, the developer can plug in code to render the music according to the tempo property, and enjoy other benefits of the rendering engine such as predictive scheduling, latency smoothing, dynamically adjustable frame rates, and the like. Further applications include graphics animation, sound processing and composition, music instrument sequencing, force feedback control, and the like.

FIG. 2 is an illustration of a high-level diagram of a user-pluggable rendering engine. Rendering engine 200 comprises timeline 210, modifier 220, layer 230, painter 240, and paintstate 250. Timeline 210 and painter 240 are typically pluggable objects that allow a user to control the timeline and properties of objects that are associated with the timeline. Although the term “painter” may be associated with graphics implementations, the term is also applicable herein to non-graphics implementations such as sound, force-feedback, and the like as discussed above.

In operation, a canvas (not shown) can be used as the root object in scene object model. (The canvas can also serve as the controller for global animation properties.) A scene can be defined creating layers and modifiers. Users can provide user-defined functionality to the scene by attaching painters to layers and timelines to the modifiers. In an embodiment, users are provided with an application programmer interface whereby the user can attach the painters to the layers and attach the timelines to the modifiers.

Layer 230 in the various embodiments couples paintstate 250, painters 240, and modifiers 220 together. In other embodiments, layer 230 can be omitted and properties 250 can be coupled more directly to the painters and modifiers.

Multiple layers can be used in an animated scene. A layer can be used to abstractly represent a desired atomic operation. In an example using the context of graphics rendering, a layer can be used to represent the rendering of a text string or a bitmap image. Each layer typically has an associated set of properties (such as position, size, opacity, and the like) for representing and controlling graphic objects.

Typically, any number of arbitrary properties can be associated with a layer. Any developer can assign a new property to a layer by uniquely defining an identifier and value for the property. Because the properties are abstractly represented, the rendering engine renderer (not shown) does not need to know the implementation details of a given property.

In various embodiments, a layer can be used as a basic rectangular scene building element. A layer can be used to represent a single painting operation which is implemented by the associated painter object. Layers can be organized hierarchically, such that a layer can have one or more children but normally have a single parent.

In an embodiment, sibling layers can have a z-order equivalent to the order in which they are attached to their parent. A layer can be “brought to front” of its siblings at any time. A child layer typically has a z-order higher than its parent, but less than the parent's next highest sibling. Additionally, a child layer is normally clipped by the bounding box of its parent.

An arbitrary number of properties can be associated with a layer. The properties can be expressed in 16.16 fixed point notation. (Other formats such as floating point notation can be used as well). The core layer properties typically include visibility, position, and size. Layers can be docked to a combination of the top, left, right, and bottom edges of the parent. A single layer property can be modified by multiple modifiers. A layer is normally associated with exactly one painter (discussed below with respect to painter 240) which implements the painting operation.

The rendering engine can act upon the properties of objects in layers in accordance with arbitrary timelines. A layer property can be animated using modifier 220. Modifier 220 is an object that defines the way a property is to be adjusted, for example, over the course of a given timeline. The timeline typically defines the path of property will follow from start to in value over a specific time interval. A developer can define an arbitrary timeline function by implementing time line 210. Timeline 210 can then be associated with a plurality of modifiers 220.

A timeline is effectively a function f(t) which describes the proportionate amount by which a layer property is perturbed over the time interval [t₀, t_{f}]. In various embodiments, the values for the time interval can be determined by a timeline, for example, or defined as given below:

t₀=0., t_{f}=1. (1)

A timeline can be associated with multiple modifiers.

Furthermore, the plurality of modifiers 220 can be attached to a single property via a modifier in a stack. The rendering engine can aggregate the set of modifiers attached to a property in the order of the stack. In this way a developer can create complex animation curves using a handful of primitive operations.

For example, a modifier can be used to define how a layer property is perturbed over a given timeline. A single layer property can be perturbed by multiple modifiers. Modifiers are associated with a property in a stack pattern. The rendering engine efficiently traverses the stack pattern: for example, if the top modifier is an “assign,” the stack need not be traversed further.

A single modifier can perturb multiple properties in multiple layers. A modifier is associated with a single timeline (which defines f(t)) and two values v₁ and v₂. A modifier can perturb any given layer property p using the following strategies:

Assign:
The layer property is assigned the timeline value, e.g.:

p=f(t)*(v₂−v₁)+v₁ (2)

Offset:
The layer property is offset from current value by timeline amount, e.g.:

p=p₀+f(t)*(v₂−v₁)+v₁ (3)

Rebase:
The layer property offset from current value by rebased (e.g., f(t₀)=p₀) timeline amount, e.g.:

p=p₀+f(t)*(v₂−p₀) (4)

Converge:
The layer property is assigned the timeline value scaled by the function j(t)=t, e.g.:

p=f(t)*(v₂−v₁)*t+v₁ (5)

The timeline itself can be can be transformed for each layer modification:

Negatively:

f′(t)=−1*f(t) (6)

Reversed:

f′(t)=f(t₀+t_{f}−t) (7)

A modifier can temporarily or permanently modify a layer property. If a modifier is set to temporarily modify a layer property, the effect of the given modifier can be eliminated when the modifier is disassociated from the property. At completion of timeline, a callback can be invoked. Timelines can be automatically looped at completion or manually looped via a callback mechanism.

Each layer is typically associated with a painter 240. Painter 240 is used to execute a desired layer operation. In a graphics rendering example, the painter can be used to generate the image pixels associated with that layer. In a sound generation example, the painter can be used to produce a digitized waveform.

The developer can create the painter by implementing the interface for painter 240. Painted 240 can then be associated with the plurality of layer objects. The behavior of painter 240 with respect to its parent layer can be defined by the properties associated with the layer. The painter can query these properties by the properties identifier using the property container object which can be passed to painter 240 by a central rendering engine. In various embodiments, painter 240 implements a single painting operation such as a draw image, draw text, a blur effect, and the like.

A painter can be associated with multiple layers so operations for the painted object can be coordinated by the layers. When painting, a painter can be queried for properties such as visibility and opacity. For example, when the value of opacity is true (or “non-zero,” or other suitable quantification), a higher layer can be painted on a second pass of a painting algorithm so that the higher layer can operate on the pixels that render beneath it.

A painter is normally called multiple times on a single paint pass. For example, an OnPaintBegin call can be made once at start of a paint operation, an OnPaint call can be made for each rectangular region of the layer requiring paint, and an OnPaintEnd call can be called once at end of a paint operation.

A painter typically operates in response to changes in properties. A painter can query layer properties via the paintstate object 250 which is normally passed to the painter at paint time. A painter can notify its attached layer of content change via the event object, which signals the layer to redraw itself.

In various embodiments, the rendering engine comprises an image painter and a text painter. The image painter loads bitmaps and icons from a resource or a disk, for example, and renders the loaded bitmap to a layer. The image painter can use an imaging library and support various image formats and color depths. The text painter renders text strings to a layer. The user can normally define the font and style of the text string. Other type painters can be used, such as three-dimensional modeling objects, sound generation and synthesis modules, force feedback controllers, and the like.

FIG. 3 is a high-level illustration of a flow diagram for user-controlled animation of renderings. In operation 302, layer for rendering an object is provided. The object can be a graphical object (such as a bitmap or model of a three-dimensional object), a sound (such a wave file, MIDI commands, or music synthesis), force feedback control (such as a steering wheel-type interface that provides variable resistance, chair movers, and other tactile feedback mechanisms), and the like.

Thus, the layer can be used to represent an atomic graphics operation for rendering a text string or a bitmap image. The layer properties can be properties such as position, size, and opacity.

In operation 304, an application programmer interface of the layer is exposed so that a user can provide specifies properties for rendering the object. The application programmer interface of the layer also provides an interface for user-supplied painter routines for rendering a graphic object, sound, or feedback force. The interfaced user-supplied painter routine can also be used to control multiple layers. The interfaced user-supplied painter routine typically queries a container object of the properties of a unique user-supplied property using a unique identifier for the unique user-supplied property.

A painter can be associated with multiple layers so operations for the painted object can be coordinated by the layers. When painting, a painter can be queried for properties such as visibility and opacity.

In operation 306, the layer is coupled to a modifier for perturbing the values of the user-specified properties. Multiple layers and modifiers can also be provided, where each layer and each modifier have a one-to-one relationship so that a modifier perturbs the current value of a property in the related layer. Multiple modifiers can also be used to perturb the current value of a single user-specified property.

The modifiers can be associated with the user-supplied properties in a stack pattern such that the user-supplied properties are evaluated in accordance with the stack pattern order. The operation can efficiently traverse the stack pattern by using heuristics: for example, if the top modifier is an “assign,” the stack need not be traversed further.

In operation 308, exposing an application programmer interface of the modifier whereby a user provides routines for perturbing the current values of the user-specified properties. A user can provide a timeline that determines how the values of the user-specified properties are perturbed over time.

The above specification, examples and data provide a complete description of the manufacture and use of embodiments of the invention. Since many embodiments of the invention can be made without departing from the spirit and scope of the invention, the invention resides in the claims hereinafter appended.

We claim:

1. A computer-implemented method for rendering objects, comprising:
providing a layer for rendering an object;
exposing an application programmer interface of the layer whereby a user provides specifies properties for rendering the object;
coupling the layer to a modifier for perturbing the values of the user-specified properties; and
exposing an application programmer interface of the modifier whereby a user provides routines for perturbing the current values of the user-specified properties.

2. The method of claim 1 wherein multiple layers and modifiers are provided, with each layer and each modifier having a one-to-one relationship wherein a modifier perturbs the current value of a property in the related layer.

3. The method of claim 1 wherein the layer represents an atomic graphics operation for rendering a text string or a bitmap image.

4. The method of claim 2 wherein the layer properties comprise position, size, and opacity.

5. The method of claim 1 wherein a timeline determines how the values of the user-specified properties are perturbed over time.

6. The method of claim 5 wherein the timeline is user-supplied.

7. The method of claim 6 wherein multiple modifiers are used to perturb the current value of a single user-specified property.

8. The method of claim 1 wherein the application programmer interface of the layer also provides an interface for user-supplied painter routines for rendering a graphic object, sound, or feedback force.

9. The method of claim 8 wherein an interfaced user-supplied painter routine controls multiple layers.

10. The method of claim 9 wherein the interfaced user-supplied painter routine queries a container object of the properties of a unique user-supplied property using a unique identifier for the unique user-supplied property.

11. The method of claim 1 wherein the modifiers are associated with the user-supplied properties in a stack pattern such that the user-supplied properties are evaluated in accordance with the stack pattern order.

12. A system for rendering objects, comprising:
a painter for providing specifies properties for rendering an object;
a modifier for perturbing the values of the specified properties; and
a user-provided timeline for controlling the perturbation of the values of the specified properties by the modifier.

13. The system of claim 12 wherein the timeline itself can be can be transformed for each layer modification.

14. The system of claim 13 wherein the timeline is negatively transformed for each layer modification.

15. The system of claim 13 wherein the timeline is reversed transformed for each layer modification.

16. The system of claim 12 further comprising a paintstate object by which the painter queries properties of an object to be rendered.

17. The system of claim 12 wherein the modifier is aggregated in a stack with other modifiers.

18. A tangible medium comprising computer-executable instructions for:
providing a layer for rendering an object;
exposing an application programmer interface of the layer whereby a user provides specifies properties for rendering the object;
coupling the layer to a modifier for perturbing the values of the user-specified properties; and
providing a timeline for perturbing the current values of the user-specified properties.

19. The tangible medium of claim 18 wherein the object to be rendered is a sound.

20. The tangible medium of claim 18 wherein the timeline comprises a starting time and an ending time.
